(19) United States
(12) Patent Application Publication
(10) Pub. No.: US 2020/0217469 A1
(43) Pub. Date: Jul. 9, 2020

(54) ELECTRONIC CANDLE LAMP

(71) Applicant: SHENZHEN TONGFANG OPTOELECTRONIC TECHNOLOGY CO., LTD, Shenzhen (CN)

(72) Inventors: Baosheng FAN, Shenzhen (CN); Huaming CUI, Shenzhen (CN)

(73) Assignee: SHENZHEN TONGFANG OPTOELECTRONIC TECHNOLOGY CO., LTD, Shenzhen (CN)

(21) Appl. No.: 16/374,361

(22) Filed: Apr. 3, 2019

Related U.S. Application Data
(63) Continuation of application No. PCT/CN2019/070901, filed on Jan. 8, 2019.

(51) Int. Cl. F21S 10/04; F21S 6/00; F21V 23/02; F21V 3/02; F21V 3/06

(52) U.S. Cl. CPC F21S 10/046; F21S 6/001; F21Y 2115/10; F21V 3/02; F21V 3/062; F21V 23/023

(57) ABSTRACT

An electronic candle lamp includes an outer cylinder arranged vertically with a top plate, and an opening at a bottom. A fixed cylinder with an opening at a bottom is positioned within the outer cylinder at the first through hole. A fixed plate with a second through hole is provided on a top of the fixed cylinder, on which a bracket is arranged with an upper portion extending though the second through hole and a lower portion positioned within the fixed cylinder, an LED lamp electrically connected with the PCB board is disposed on the bracket, a light transmitting body is suspended above the top of the LED lamp and arranged vertically, a bottom of the light transmitting body is connected with a pendulum in the fixed cylinder by a connecting member, a magnet is fixed at the bottom of the pendulum, opposite to and spaced from the electromagnetic coil.

### CROSS-REFERENCE TO RELATED APPLICATIONS

This application is a bypass continuation of International Application No. PCT/CN2019/070901, filed Jan. 8, 2019 in the China National Intellectual Property Administration. All disclosures of the document named above are incorporated herein by reference.

### TECHNICAL FIELD

The present invention relates to the field of illumination, and in particular relates to an electronic candle lamp.

### BACKGROUND

Typical electronic candle lamps employ LED lamps to illuminate an oscillating flame piece from sides to achieve an effect of simulating oscillating burning flame. However, a complete flame shape can only be seen from a front side directly lighten by the LED lamps and a rear side opposite to the front side, and an incomplete flame shape will be seen from other aspects, resulting in a poor effect of simulating oscillating burning flame.

In addition, the existing electronic candle lamps illuminate the flame piece by light emitted from the LED lamps, with extremely low lighting efficiency and unsatisfied illumination effect.

Moreover, the flame piece has limited structural changes and cannot meet diverse needs of the consumer.

### SUMMARY

It is an objective of the present invention to overcome the deficiencies of the prior art described above and to provide an electronic candle lamp.

The present invention is achieved as follows: electronic candle lamp comprises an outer cylinder arranged vertically with a top plate fixedly provided on a top of the outer cylinder, and an opening provided at a bottom of the outer cylinder, wherein a battery pack is fixedly disposed at the opening at the bottom of the outer cylinder, a first through hole is provided in the top plate, a fixed cylinder is vertically positioned within the outer cylinder at the first through hole, a fixed plate is fixedly provided on a top of the fixed cylinder, a second through hole is provided in the fixed plate, an opening is provided at the bottom of the fixed cylinder, a base is fixedly arranged at the opening at the bottom of the fixed cylinder, a PCB is fixedly mounted on the base, the battery pack is electrically connected with the PCB, and an electromagnetic coil is provided on the PCB and connected thereto; wherein a bracket is fixedly arranged on the fixed plate with an upper portion of the bracket extending though the second through hole, and a lower portion of the bracket positioned within the fixed cylinder, an LED lamp electrically connected with the PCB board is fixedly disposed on a top of the bracket, a light transmitting body is suspended above a top of the LED lamp and arranged vertically, a bottom of the light transmitting body is connected with a pendulum positioned within the fixed cylinder by means of a connecting member, a magnet is fixed at the bottom of the pendulum, and the magnet is directly opposite to and spaced apart from the electromagnetic coil.

Particularly, a first fixing slot is provided in an inner side wall of the fixed cylinder for fixing the lower portion of the bracket, and a second fixing slot is provided in the fixed plate for fixing a middle portion of the bracket.

Particularly, a top of the LED lamp is recessed downwards to form a first groove, the center of the bottom of the light transmitting body is recessed inwards to form a blind hole, the blind hole is opened downwards, an inverted conical projection is provided on a top of the blind hole, the LED lamp is positioned within the blind hole, and a tip of the conical projection abuts against a bottom of the first groove.

Particularly, the connecting member is an arc-shaped connecting sheet, an arc-shaped limiting flange is provided on an inner wall of a lower portion of the connecting member, a second annular groove is provided in a top of the pendulum, a middle portion of an inner circumferential surface of the second groove is recessed inwards to form a limiting groove, a lower end of the connecting member is insertable in the second groove, and the limiting flange is snap-fit with the limiting groove.

Particularly, the light transmitting body is a solid of revolution.

Particularly, the light transmitting body is made of PMMA or PC.

The electronic candle lamp provided by the present invention has the following technical effects.

(1) Since the light transmitting body of the present invention is suspended above the LED lamp, when the light transmitting body is illuminated by the LED lamp, a complete flame shape can be seen from various aspects, this may achieve a better effect of simulating a oscillating burning flame, and solves the problem that the complete flame shape can only be seen from a front side and a rear side of flame piece lighten by the LED laterally in the prior art.

(2) Since the light transmitting body of the present invention is suspended above the LED lamp, the light emitted from the LED lamp may emit out of the light transmitting body from all directions, so that the area around the electronic candle lamp may be illuminated to satisfy a need of using the electronic candle lamp for illumination.

(3) The light transmitting body of the present invention is snap-fit with the pendulum by means of the connecting member, in use, light transmitting bodies may be replaced with different shapes, different colors or different sizes according to preferences of the consumer, or with a new light transmitting body in the event of failure to make sure normal use of the electronic candle lamp. During transport, the light transmitting body can be removed to reduce the size of a packaging box, thus decreasing the consumption of a packaging material, and lowering the production cost. Further, the configuration of the light transmitting body has more varieties than that of an existing flame piece, and the consumer can choose light transmitting bodies with different configurations.

### BRIEF DESCRIPTION OF THE DRAWINGS

In order to more clearly illustrate the technical solutions of the present invention, accompanying drawings referred to in the embodiments will be briefly described below. It is appreciated that the accompanying drawings in the following descriptions are only some embodiments of the present invention. Those ordinarily skilled in the art may obtain other accompanying drawings according to these accompanying drawings without any creative work.

FIG. 1 is a schematic diagram showing an internal structure of an electronic candle lamp according to an embodiment of the present invention;

FIG. 2 is a schematic diagram showing an internal structure of a fixed cylinder of FIG. 1;

FIG. 3 is a schematic exploded view showing an internal structure of a fixed cylinder of FIG. 1; and

FIG. 4 is a schematic exploded view showing an internal structure of a fixed cylinder of FIG. 1 from another aspect.

### DESCRIPTION OF THE EMBODIMENTS

The technical solutions in embodiments of the present invention will be clearly and completely described in the following with reference to accompanying drawings.

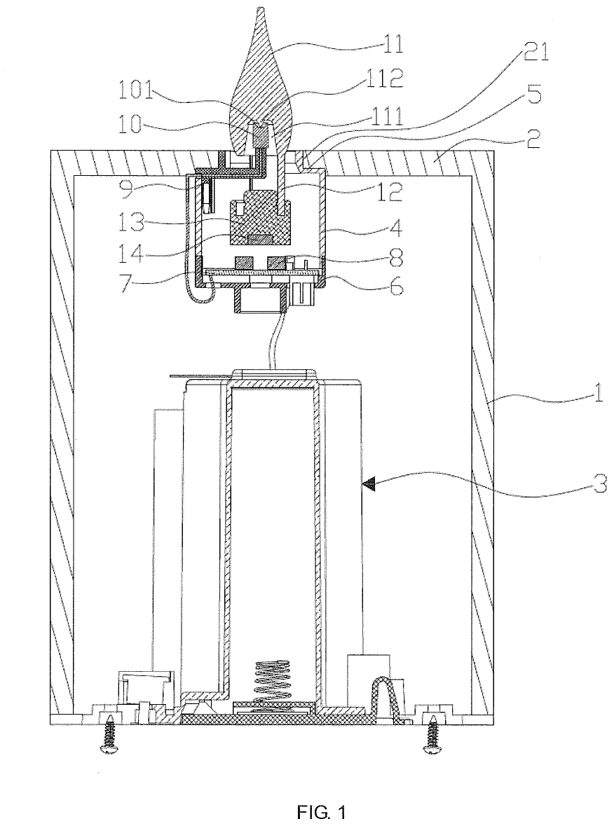

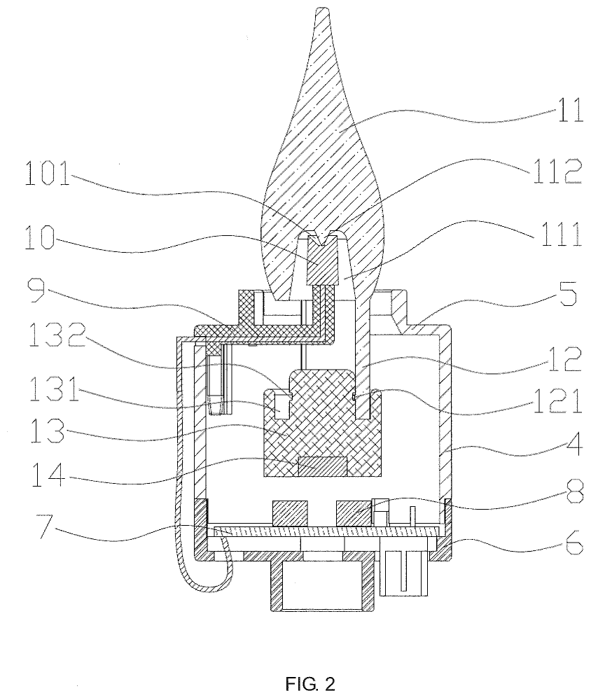

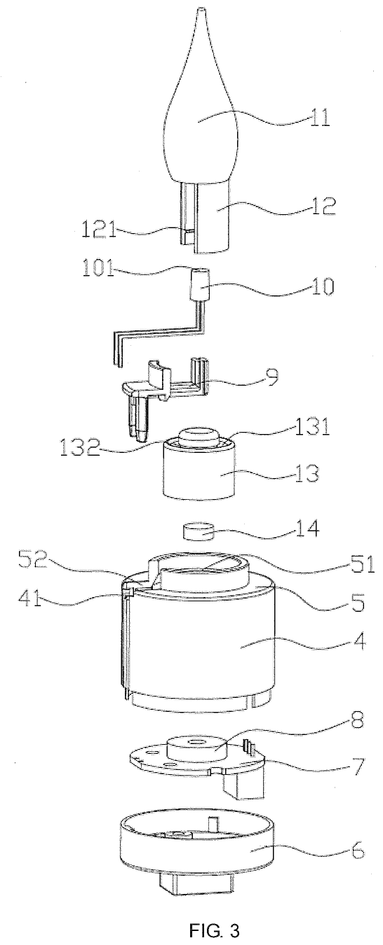

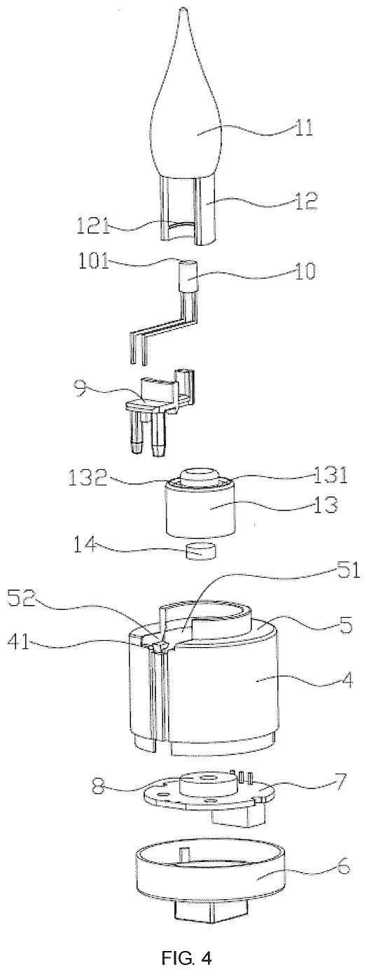

As shown in FIG. 1 to FIG. 4, an electronic candle lamp according to an embodiment of the present invention includes an outer cylinder 1 arranged vertically, with a top plate 2 integrally formed on the top thereof, and an opening provided at the bottom thereof. A battery pack 3 is fixedly arranged at the opening at the bottom of the outer cylinder 1. A first through hole 21 is provided in the top plate 2, and a fixed cylinder 4 is vertically arranged within the outer cylinder 1 at the first through hole 21. A fixed plate 5 is integrally formed on the top of the fixed cylinder 4. A second through hole 51 is provided in the fixed plate 5. An opening is provided at the bottom of the fixed cylinder 4, and a base 6 is fixedly disposed at the opening at the bottom of the fixed cylinder 4. A PCB 7 is fixedly arranged on the base 6, the battery pack 3 is electrically connected with the PCB 7, and an electromagnetic coil 8 is provided on the PCB 7 and connected thereto.

A bracket 9 is fixedly arranged on the fixed plate 5, an upper portion of the bracket 9 extends through the second through hole 51, and a lower portion of the bracket 9 is arranged within the fixed cylinder 9. An LED 10 electrically connected with the PCB board 7 is fixedly mounted on the top of the bracket 9. A light transmitting body 11 is suspended above the top of the LED lamp 10 and disposed vertically. The bottom of the light transmitting body 11 is fixedly connected with a pendulum 13 positioned within the fixed cylinder 4 by means of a connecting member 12. A magnet 14 is fixed to the bottom of the pendulum 13, and the magnet 14 is directly opposite to and spaced apart from the electromagnetic coil 8.

Particularly, the fixed plate 5 and the bracket 9 are connected in such a manner that a second fixing slot 52 is provided in the fixed plate 5, and a middle portion of the bracket 9 is clamped in the second fixing slot 52 during installation, such that the fixed plate 5 is fixedly connected with the bracket 9. In order to further secure the bracket 9, a first fixing slot 41 is provided in an inner side wall of the fixed cylinder 4, the lower portion of the bracket 9 is clamped in the first fixing slot 41, so that the bracket 9 is fixed more firmly.

Particularly, the light transmitting body 11 is suspended above the top of the LED lamp 10 in such a manner that the top of the LED lamp 10 is recessed downwards to form a first groove 101, the center of the bottom of the light transmitting body 11 is recessed inwards to form a blind hole 111, the blind hole 111 is opened downwards, an inverted conical projection 112 is fixedly provided on the top of the blind hole 111, the LED lamp 10 is positioned within the blind hole 111, and a tip of the projection 112 abuts against the bottom of the first groove 111, so that the light transmitting body 11 is suspended above the top of the LED lamp 10.

Particularly, the light transmitting body 11 and the pendulum 13 are connected via the connecting member 12 in such a manner that the connecting member 12 is an arc-shaped connecting sheet, an arc-shaped limiting flange 121 is fixedly provided on an inner wall of a lower portion of the connecting member 12, a second annular groove 131 is provided in the top of the pendulum 13, a middle portion of an inner circumferential surface of the second groove 131 is recessed inwards to form a limiting groove 132, the lower end of the connecting member 12 is insertable in the second groove 131, and the limiting flange 121 is snap-fit with the limiting groove 132, so that the bottom of the light transmitting body 11 is fixedly connected with the pendulum 13 by means of the connecting member 12.

Particularly, the light transmitting body 11 is a solid of revolution, which may be of a shape such as a gourd shape or a teardrop shape.

Particularly, the light transmitting body 11 is made of PMMA or PC.

An operating principle of the electronic candle lamp provided by the present invention is as follows: the PCB 7 controls the battery pack 3 to supply a stable direct current to the LED lamp 10, the LED lamp 10 is in a normally on state, light emitted from the LED lamp 10 illuminates the light transmitting body 11; when the PCB 7 controls the battery pack 3 to supply a direct current to the electromagnetic coil 8, the electromagnetic coil 8 generates a magnetic field after being energized, a magnetic force of the magnetic field repels the magnet 14 to move the magnet 14 away from the electromagnetic coil 8; when the PCB 7 cuts off the power supply from the battery pack 3 to the electromagnetic coil 8, the magnetic field generated by the electromagnetic coil 8 disappears, and the magnet 14 moves toward the electromagnetic coil 8 under an action of its own gravity, so that the magnet 14 oscillates back and forth, and thus the light transmitting body 11, the connecting member 12 and the pendulum 13 oscillate back and forth together with the magnet 14, and back-and-forth oscillation of the light transmitting body 11 may achieve an effect of simulating a burning flame oscillating back-and-forth.

The electronic candle lamp provided by the present invention has the following technical effects.

(1) Since the LED lamp 10 of the present invention is arranged within the blind hole 111 of the light transmitting body 11, when the light transmitting body 11 is illuminated by the LED lamp 10, a complete flame shape can be seen from various aspects, this may achieve a better effect of simulating a oscillating burning flame, and solves the problem that the complete flame shape can only be seen from a front side and a rear side of flame piece lighten by the LED laterally in the prior art.

(2) Since the LED lamp 10 of the present invention is arranged within the blind hole 111 of the light transmitting body 11, the light emitted from the LED lamp 10 may emit out of the light transmitting body 11 from all directions, so that the area around the electronic candle lamp may be illuminated to satisfy a need of using the electronic candle lamp for illumination.

(3) The light transmitting body 11 of the present invention is snap-fit with the pendulum 13 by means of the connecting member 12, in use, light transmitting bodies 11 may be replaced with different shapes, different colors or different sizes according to preferences of the consumer, or with a new light transmitting body 11 in the event of failure to make sure normal use of the electronic candle lamp. During transport, the light transmitting body 11 can be removed to reduce the size of a packaging box, thus decreasing the consumption of a packaging material, and lowering the production cost. Further, the configuration of the light transmitting body 11 has more varieties than that of an existing flame piece, and the consumer can choose light transmitting bodies 11 with different configurations.

The above is a preferred embodiment of the present invention, and it should be noted that those skilled in the art may also make various improvements and modifications without departing from the principles of the present invention, and these improvements and modifications are deemed to be within a scope of protection of the present invention.

What is claimed is:

1. An electronic candle lamp comprising an outer cylinder arranged vertically with a top plate fixedly provided on a top of the outer cylinder, and an opening provided at a bottom of the outer cylinder, wherein a battery pack is fixedly disposed at the opening at the bottom of the outer cylinder, a first through hole is provided in the top plate, a fixed cylinder is vertically positioned within the outer cylinder at the first through hole, a fixed plate is fixedly provided on a top of the fixed cylinder, a second through hole is provided in the fixed plate, an opening is provided at the bottom of the fixed cylinder, a base is fixedly arranged at the opening at the bottom of the fixed cylinder, a PCB is fixedly mounted on the base, the battery pack is electrically connected with the PCB, and an electromagnetic coil is provided on the PCB and connected thereto;
characterized in that, a bracket is fixedly arranged on the fixed plate with an upper portion of the bracket extending though the second through hole, and a lower portion of the bracket positioned within the fixed cylinder, an LED lamp electrically connected with the PCB board is fixedly disposed on a top of the bracket, a light transmitting body is suspended above a top of the LED lamp and arranged vertically, a bottom of the light transmitting body is connected with a pendulum positioned within the fixed cylinder by means of a connecting member, a magnet is fixed at a bottom of the pendulum, and the magnet is directly opposite to and spaced apart from the electromagnetic coil.

2. The electronic candle lamp according to claim 1, wherein a first fixing slot is provided in an inner side wall of the fixed cylinder for fixing the lower portion of the bracket, and a second fixing slot is provided in the fixed plate for fixing a middle portion of the bracket.

3. The electronic candle lamp according to claim 1, wherein a top of the LED lamp is recessed downwards to form a first groove, the center of the bottom of the light transmitting body is recessed inwards to form a blind hole, the blind hole is opened downwards, an inverted conical projection is provided on a top of the blind hole, the LED lamp is positioned within the blind hole, and a tip of the conical projection abuts against a bottom of the first groove.

4. The electronic candle lamp according to claim 1, wherein the connecting member is an arc-shaped connecting sheet, an arc-shaped limiting flange is provided on an inner wall of a lower portion of the connecting member, a second annular groove is provided in a top of the pendulum, a middle portion of an inner circumferential surface of the second groove is recessed inwards to form a limiting groove, a lower end of the connecting member is insertable in the second groove, and the limiting flange is snap-fit with the limiting groove.

5. The electronic candle lamp according to claim 1, wherein the light transmitting body is a solid of revolution.

6. The electronic candle lamp according to claim 1, wherein the light transmitting body is made of PMMA or PC.
